(19) United States
(12) Patent Application Publication
(10) Pub. No.: US 2013/0100717 A1
(43) Pub. Date: Apr. 25, 2013

(54) DC-AC POWER CONVERTING APPARATUS AND SOLAR POWER SUPPLYING APPARATUS INCLUDING THE SAME

(71) Applicant: SAMSUNG ELECTRO-MECHANICS CO., LTD., Suwon-si (KR)

(72) Inventors: Tae Won LEE, Suwon-si (KR); Min Ho HEO, Suwon-si (KR); Jun Gu KIM, Suwon-si (KR); Young Hyok JI, Suwon-si (KR); Mi Na KIM, Suwon-si (KR); Chung Yuen WON, Suwon-si (KR)

(73) Assignee: SAMSUNG ELECTRO-MECHANICS CO., LTD., Suwon-si (KR)

(21) Appl. No.: 13/710,183

(22) Filed: Dec. 10, 2012

(30) Foreign Application Priority Data
Aug. 29, 2011 (KR) 10-2011-0095193

(51) Int. Cl. H02M 5/458

(52) U.S. Cl. CPC H02M 5/4585
USPC 363/37

(57) ABSTRACT

There is provided a DC-AC power converting apparatus that does not employ a capacitor for removing a ripple in an input terminal by charging or supplementing power according to a difference in power levels between power output by a solar cell and system instantaneous power or employs a capacitor having a low capacity, and a solar power supplying apparatus including the same. The DC-AC power converting apparatus includes: a DC-AC power converting unit that switches DC power and converts the DC power into AC power; and a charging and discharging unit that charges surplus power generated in a switching operation when a power level of the DC power is higher than a power level of the AC power and discharges the charged power through the switching operation when the power level of the DC power is lower than the power level of the AC power

### CROSS-REFERENCE TO RELATED APPLICATIONS

This application claims the priority of Korean Patent Application No. 10-2012-0095193 filed on Aug. 29, 2012, in the Korean Intellectual Property Office, the disclosure of which is incorporated herein by reference.

### BACKGROUND OF THE INVENTION

1. Field of the Invention

The present invention relates to a DC-AC power converting apparatus in which a converter and an inverter are integrated in a single power conversion circuit and a solar power supplying apparatus including the DC-AC power converting apparatus.

2. Description of the Related Art

From the end of the 20^{th} century, demands for and development of renewable sources of energy sources have increased due to depletion of fossil fuels and the seriousness of environmental pollution and global warming caused by carbon, NOx, SOx, etc. In particular, demand for a technological development has sharply risen due to the start of obligations to reduce greenhouse gas emissions in accordance with the Kyoto Protocol and a sharp rise in international oil prices. Accordingly, the modern problem of depleted energy resources is directly related to national security issues, and technologies for a reduction in the emission of carbon and a will to implement such technologies are recognized as boosting national competitiveness.

Further, among a variety of renewable energy sources, a market for solar cells (also called a photovoltaic (PV) cells), supplying an inexhaustible clean source of energy and having an advantage in being manufacturable by the domestic Korean semiconductor industry, has consistently grown, in spite of low efficiency thereof or the like in solar cells recently released onto the Korean market. Internationally, a solar power supplying apparatus using the solar cell (PV cell) has been entirely commercialized with the leadership of Japan and Germany, based on long-term accumulated technical skills and financial power.

Such a solar power supplying apparatus generally employs a converter that converts DC power from the solar cell (PV cell) into DC power having a uniform level, and an inverter that converts the DC power of the converter into a commercial AC power as in the Related Art Document below. Power conversion efficiency is the most important issue with respect to the converter and the inverter.

To achieve power conversion efficiency, a DC-AC power converting apparatus in which the converter and the inverter are integrated in a single power converting circuit tends to be a substitute. However, although such DC-AC power converting apparatus uses a high capacity electrolytic capacitor in an input terminal so as to reduce a low frequency voltage ripple in the input terminal caused by a fluctuation of an output voltage, the capacity of the electrolytic capacitor increases the size of the circuit, and the lifespan of the solar power supplying apparatus that needs to be used for at least several years to several tens of years may be reduced due to the electrolytic capacitor.

### RELATED ART DOCUMENT

Korean Patent Laid-Open Publication No. 10-2009-0133036

### SUMMARY OF THE INVENTION

An aspect of the present invention provides a DC-AC power converting apparatus that does not employ a capacitor for removing a ripple in an input terminal by charging or supplementing power according to a difference in power levels between power output by a solar cell and system instantaneous power or that employs a capacitor having a relatively low capacity, and a solar power supplying apparatus including the DC-AC power converting apparatus.

According to an aspect of the present invention, there is provided a DC-AC power converting apparatus including: a DC-AC power converting unit that switches DC power and converts the DC power into AC power; and a charging and discharging unit that charges surplus power generated in a switching operation when a power level of the DC power is higher than a power level of the AC power and discharges the charged power through the switching operation when the power level of the DC power is lower than the power level of the AC power.

The charging and discharging unit may include: a charging switch that provides a path for charging the surplus power generated in the switching operation when the power level of the DC power is higher than the power level of the AC power; a discharging switch that provides a path for discharging the power charged through the switching operation when the power level of the DC power is lower than the power level of the AC power; and capacitor units that charge or discharge the power according to the switching operations of the charging switch and the discharging switch.

The charging switch and the discharging switch may be alternately switched on and off.

The charging and discharging unit may further include an inductor unit that LC resonates with the capacitor units and provides soft switching operations of the charging switch and the discharging switch.

The DC-AC power converting unit may include: a converter that switches the DC power and converts the DC power into a first DC power having a previously set frequency; and an inverter that switches the first DC power and converts the AC power.

The converter may include: a power switch that switches the DC power; a transformer including a primary coil that receives power by the switching of the power switch and a secondary coil that has a previously set coil ratio with regard to the primary coil and outputs power having a voltage level according to the coil ratio; an output switch that switches a power output from the secondary coil of the transformer; an output diode that provides an output path for the power switched by the output switch; and an output capacitor that stabilizes the power from the output diode.

The inverter may include: an inverter circuit that switches the first DC power and converts the first DC power into AC power; and a stabilization circuit that stabilizes the AC power converted from the inverter circuit.

The DC-AC power converting apparatus may further include: an input filter capacitor that reduces a ripple in an input terminal occurring due to a fluctuation of the AC power.

The first DC power may be an unfolding power in the form of a rectified sine wave signal.

The DC-AC power converting apparatus may further include: a control unit that controls power switching of the DC-AC power converting unit and charging and discharging switching of the charging and discharging unit.

According to another aspect of the present invention, there is provided a solar power supplying apparatus including: a solar cell that collects solar light and converts the solar light into DC power; a DC-AC power converting unit that switches the DC power from the solar cell and converts the DC power into AC power; and a charging and discharging unit that charges surplus power generated in a switching operation when a power level of the DC power is higher than a power level of the AC power and discharges the charged power through the switching operation when the power level of the DC power is lower than the power level of the AC power.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic diagram of a lay-out of a general solar power generation system;

FIG. 2 is a waveform graph of output power of a solar cell and system instantaneous power;

FIG. 3 is a schematic circuit diagram of a DC-AC power converting apparatus according to an embodiment of the present invention; and

FIG. 4 is a voltage waveform graph of a main part of the DC-AC power converting apparatus of FIG. 3.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

A case in which any one part is connected to the other part includes a case in which the parts are directly connected to each other and a case in which the parts are indirectly connected to each other with other elements interposed therebetween.

In addition, unless explicitly described otherwise, “comprising” any components will be understood to imply the inclusion of other components but not the exclusion of any other components.

Embodiments of the present invention will now be described in detail.

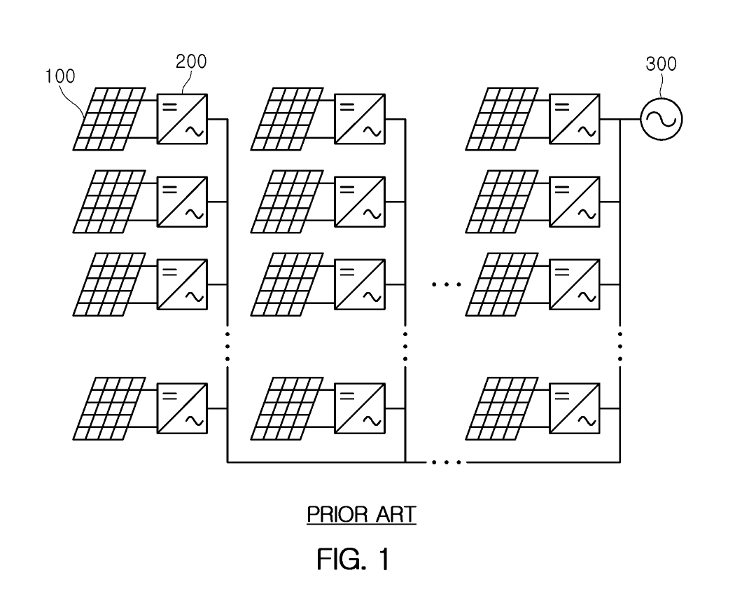

FIG. 1 is a schematic diagram of a lay-out of a general solar power generation system.

Referring to FIG. 1, the general solar power generation system may include a solar cell 100 and a DC-AC power converting apparatus 200.

The DC-AC power converting apparatus 200 may convert DC power from the solar cell 100 into AC power having a previously set voltage level. The solar cell 100 and the DC-AC power converting apparatus 200 may be plural. The AC power from the plurality of the DC-AC power converting apparatuses 200 may be provided to a linked commercial power system 300.

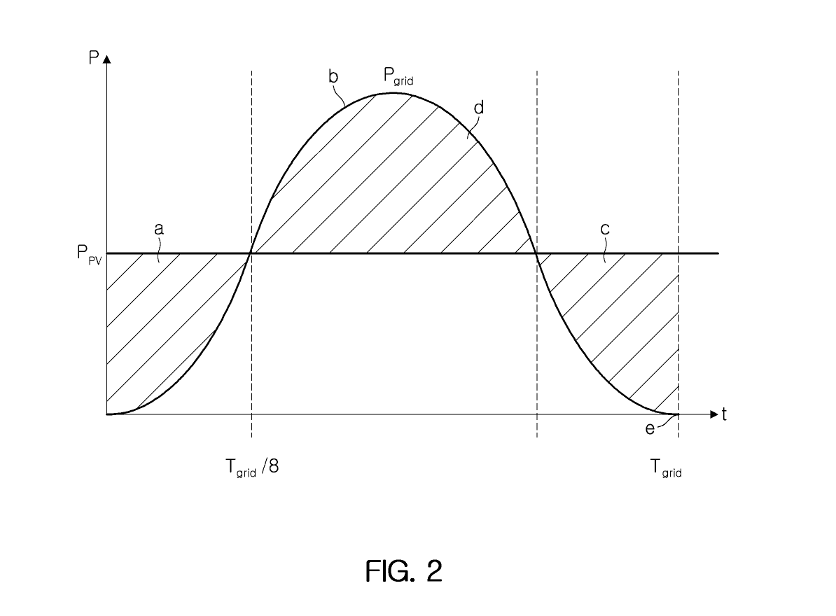

FIG. 2 is a waveform graph of output power of a solar cell and system instantaneous power.

Referring to FIG. 2, the output power of the solar cell may have a uniform value such as in reference numeral a, and the system instantaneous power may have a waveform of an AC signal such as in reference numeral b.

The system instantaneous power may have a value that instantly varies with respect to a cycle e. A Dower difference in power levels between input power and output power may be indicated as reference numerals c and d.

That is, when the output power of the solar cell is greater than the system instantaneous power, surplus power corresponding to the difference therebetween may be charged into an input filter capacitor of an input terminal. On the contrary, when the output power of the solar cell is lower than the system instantaneous power, the difference therebetween indicates an insufficient amount of the power that is supplied to a system, and thus the power charged into the input filter capacitor may be discharged. Such an input filter capacitor may employ a high capacity electrolytic capacitor to charge and discharge a sufficient amount of power, which may cause an increase in an area of a circuit and a reduction in the lifespan of a product.

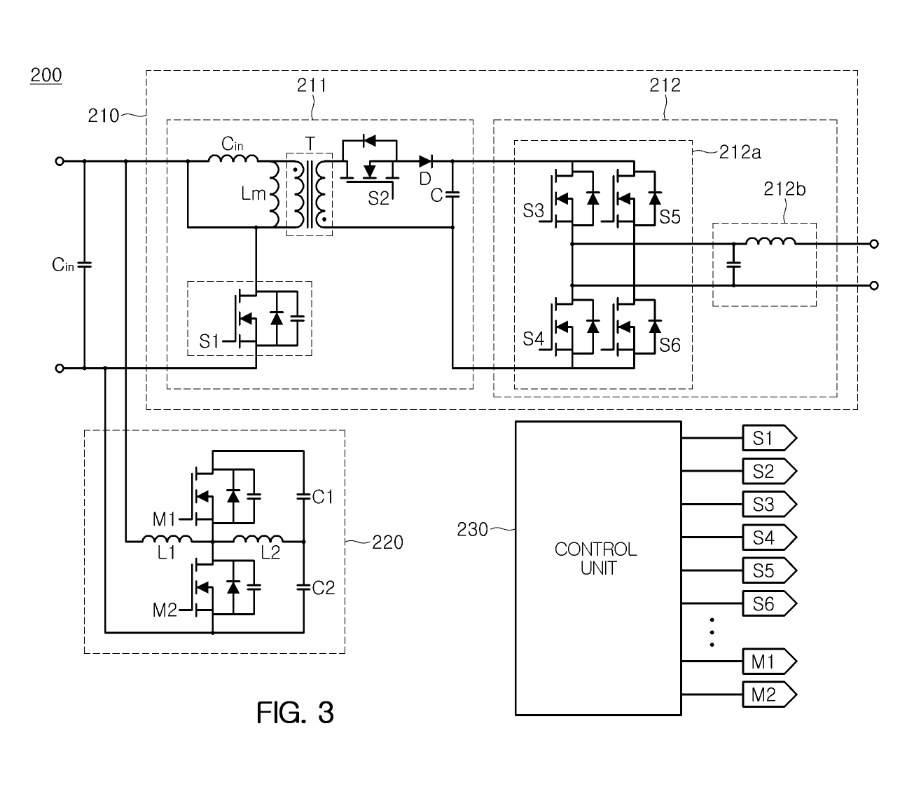

FIG. 3 is a schematic circuit diagram of a DC-AC power converting apparatus 200 according to an embodiment of the present invention.

Referring to FIG. 3, the DC-AC power converting apparatus 200 according to the embodiment of the present invention may include a DC-AC power converting unit 210, a charging and discharging unit 220, and a control unit 230.

The DC-AC power converting unit 210 may include a converter 211 and an inverter 212.

The converter 211 may include a power switch S1 that switches DC power from a solar cell; a transformer T including a primary coil that receives power by the switching of the power switch S1 and a secondary coil that has a previously set coil ratio with regard to the primary coil and outputs power having a voltage level according to the coil ratio; an output switch S2 that switches a power output from the secondary coil of the transformer T; an output diode D that provides an output path for the power switched by the output switch S2; and an output capacitor C that stabilizes the power from the output diode D.

The inverter 212 may include an inverter circuit 212a that switches the DC power from the converter 211 and converts the DC power into AC power and a stabilization circuit 212b that stabilizes the AC power converted from the inverter circuit 212a.

The DC power from the converter 211 may be DC power having a uniform voltage level, whereas the DC power may be an unfolding power having a rectified sine wave signal. This facilitates conversion of the AC power, thereby reducing capacity of the output capacitor C, and employs a low capacity capacitor, thereby reducing manufacturing costs and an area of a circuit and preventing a reduction in the lifespan of a product.

The charging and discharging unit 220 may include a charging switch M1 that provides a path for charging the surplus power generated in a switching operation when a power level of the DC power of the solar cell 100 is greater than a power level of the AC power supplied to system instantaneous power; a discharging switch M2 that provides a path for discharging the power charged through the switching operation when the power level of the DC power of the solar cell 100 is lower than the power level of the AC power supplied to the system instantaneous power; capacitor units C1 and C2 that charge or discharge the power according to the switching operations of the charging switch M1 and the discharging switch M2; and an inductor L2 that LC resonates with the capacitor units C1 and C2 and provides soft switching operations of the charging switch M1 and the discharging switch M2. The charging and discharging unit 220 may further include an inductor L1 that charges and discharges energy according to the switching operations of the charging switch M1 and the discharging switch M2.

The above-described switching operations of the DC-AC power converting unit 210 and the charging and discharging unit 220 may be controlled by the control unit 230.

Accordingly, the charging switch M1 and the discharging switch M2 may alternately switched on and off. The charging and discharging unit 220 is charged with the surplus power generated according to a difference in power levels between the power level of the DC power of the solar cell 100 and the power level of the AC power supplied to the system instantaneous power or is discharged so as to fill insufficient power, thereby compensating for a ripple component that occurs in an input terminal. Accordingly, capacity of an input filter capacitor Cin is reduced so that a film capacitor or a ceramic capacitor may be employed other than an electrolytic capacitor or the input filter capacitor Cin may not be employed, thereby inhibiting a lifespan reduction of a product due to the employment of the electrolytic capacitor or reducing manufacturing costs and an area of a circuit owing to the employment of a capacitor.

The above-described DC-AC power converting apparatus 200 may be employed in plural in module units as shown in FIG. 1. DC power from a plurality of respective solar cells may be converted into AC power through the plurality of respective DC-AC power converting modules 200 and supplied to the linked commercial power system 300.

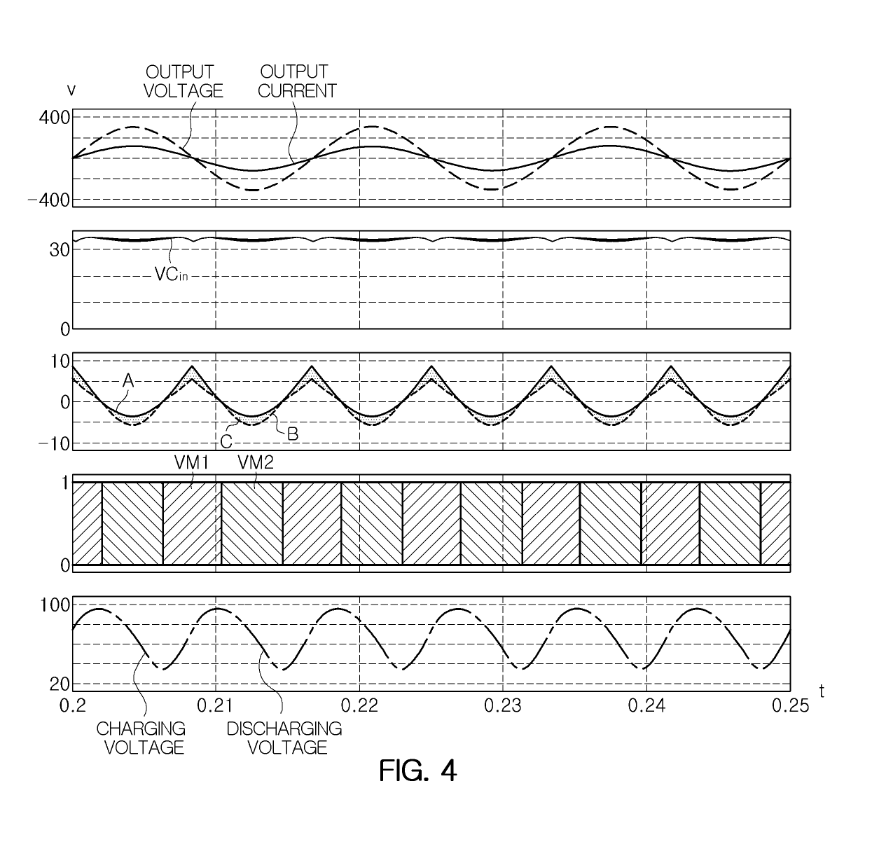

FIG. 4 is a voltage waveform graph of a main part of the DC-AC power converting apparatus 200 of FIG. 3.

Referring to FIG. 4 and FIG. 3, it can be appreciated that the charging and discharging unit 220 of the DC-AC power converting apparatus 200 has an output voltage of 311 V and an output current having no distortion, and that in a voltage VCin applied to the input filter capacitor Cin, a waveform such as a uniform DC voltage is provided rather than showing a low frequency ripple component of 120 Hz due to a system linkage.

The charging switch M1 and the discharging switch M2 may operate by using a method of controlling a hysteresis charging and discharging current, and operate in a charge mode when smaller than “0” with respect to “0” and in a discharge mode when greater than “0”. In the discharge mode with respect to a PWM OFF command value A and a PWM ON command value B that have uniform widths, in a case where a PWM signal C is greater than the PWM OFF command value A, the discharging switch M2 is switched off, and in a case where the PWM signal C is smaller than the PWM ON command value B, the discharging switch M2 is switched on. In such discharge mode, the discharging switch M2 only performs on/off switching operations, and voltages of the capacitor units C1 and C2 are charged to compensate for a positive power difference in power levels between a solar cell and system instantaneous power, and thus the voltage increases.

On the contrary, in the charge mode, in a case where the PWM signal C is greater than the PWM OFF command value A, the charging switch M1 is switched off, and in a case where the PWM signal C is smaller than the PWM ON command value B, the charging switch M1 is switched on. In such charge mode, the charging switch M1 only performs on/off switching operations, and the voltages of the capacitor units C1 and C2 are discharged to compensate for a negative power difference in power levels between the solar cell and the system instantaneous power, and thus the voltage decreases.

As set forth above, according to embodiments of the invention, a DC-AC power converting apparatus may not employ a capacitor for removing a ripple in an input terminal by charging surplus power or supplementing insufficient power according to a difference in power levels between power output by a solar cell and system instantaneous power or may employ a capacitor having a relatively low capacity, thereby inhibiting a lifespan reduction of a product due to the employment of an electrolytic capacitor.

While the present invention has been illustrated and described in connection with the embodiments thereof, it will be apparent to those skilled in the art that modifications and variations can be made without departing from the spirit and scope of the invention as defined by the appended claims.

What is claimed is:

1. A direct current/alternating current (DC-AC) power converting apparatus comprising:
a DC-AC power converting unit that switches DC power and converts the DC power into AC power; and
a charging and discharging unit charging surplus power generated in a switching operation when a power level of the DC power is higher than a power level of the AC power and discharges the charged power through the switching operation when the power level of the DC power is lower than the power level of the AC power.

2. The DC-AC power converting apparatus of claim 1, wherein the charging and discharging unit includes:
a charging switch that provides a path for charging the surplus power generated in the switching operation when the power level of the DC power is higher than the power level of the AC power;
a discharging switch that provides a path for discharging the power charged through the switching operation when the power level of the DC power is lower than the power level of the AC power; and
capacitor units that charge or discharge the power according to the switching operations of the charging switch and the discharging switch.

3. The DC-AC power converting apparatus of claim 2, wherein the charging switch and the discharging switch are alternately switched on and off.

4. The DC-AC power converting apparatus of claim 2, wherein the charging and discharging unit further includes an inductor unit that LC resonates with the capacitor units and provides soft switching operations of the charging switch and the discharging switch.

5. The DC-AC power converting apparatus of claim 1, wherein the DC-AC power converting unit includes:
a converter that switches the DC power and converts the DC power into a first DC power having a previously set frequency; and
an inverter that switches the first DC power and converts the AC power.

6. The DC-AC power converting apparatus of claim 5, wherein the converter includes:
a power switch that switches the DC power;
a transformer including a primary coil that receives power by the switching of the power switch and a secondary coil that has a previously set coil ratio with regard to the primary coil and outputs power having a voltage level according to the coil ratio;
an output switch that switches a power output from the secondary coil of the transformer;
an output diode that provides an output path for the power switched by the output switch; and
an output capacitor that stabilizes the power from the output diode.

7. The DC-AC power converting apparatus of claim 5, wherein the inverter includes:
an inverter circuit that switches the first DC power and converts the first DC power into AC power; and
a stabilization circuit that stabilizes the AC power converted from the inverter circuit.

8. The DC-AC power converting apparatus of claim 1, further comprising an input filter capacitor that reduces a ripple in an input terminal occurring due to a fluctuation of the AC power.

9. The DC-AC power converting apparatus of claim 6, wherein the first DC power is an unfolding power in the form of a rectified sine wave signal.

10. The DC-AC power converting apparatus of claim 1, further comprising a control unit that controls power switching of the DC-AC power converting unit and charging and discharging switching of the charging and discharging unit.

11. A solar power supplying apparatus comprising:
a solar cell collecting solar light and converting the solar light into DC power;
a DC-AC power converting unit switching the DC power from the solar cell and converting the DC power into AC power; and
a charging and discharging unit charging surplus power generated in a switching operation when a power level of the DC power is higher than a power level of the AC power and discharging the charged power through the switching operation when the power level of the DC power is lower than the power level of the AC power.

12. The solar power supplying apparatus of claim 11, wherein the charging and discharging unit includes:
a charging switch that provides a path for charging the surplus power generated in the switching operation when the power level of the DC power is higher than the power level of the AC power;
a discharging switch that provides a path for discharging the power charged through the switching operation when the power level of the DC power is lower than the power level of the AC power; and
capacitor units that charge or discharge the power according to the switching operations of the charging switch and the discharging switch.

13. The solar power supplying apparatus of claim 12, wherein the charging switch and the discharging switch are alternately switched on and off.

14. The solar power supplying apparatus of claim 12, wherein the charging and discharging unit further includes an inductor unit that LC resonates with the capacitor units and provides soft switching operations of the charging switch and the discharging switch.

15. The solar power supplying apparatus of claim 11, wherein the DC-AC power converting unit includes:
a converter that switches the DC power and converts the DC power into a first DC power having a previously set frequency; and
an inverter that switches the first DC power and converts the AC power.

16. The solar power supplying apparatus of claim 15, wherein the converter includes:
a power switch that switches the DC power;
a transformer including a primary coil that receives power by the switching of the power switch and a secondary coil that has a previously set coil ratio with regard to the primary coil and outputs power having a voltage level according to the coil ratio;
an output switch that switches a power output from the secondary coil of the transformer;
an output diode that provides an output path for the power switched by the output switch; and
an output capacitor that stabilizes the power from the output diode.

17. The solar power supplying apparatus of claim 15, wherein the inverter includes:
an inverter circuit that switches the first DC power and converts the first DC power into AC power; and
a stabilization circuit that stabilizes the AC power converted from the inverter circuit.

18. The solar power supplying apparatus of claim 11, further comprising an input filter capacitor that reduces a ripple in an input terminal occurring due to a fluctuation of the AC power.

19. The solar power supplying apparatus of claim 16, wherein the first DC power is an unfolding power in the form of a rectified sine wave signal.

20. The solar power supplying apparatus of claim 11, further comprising a control unit that controls power switching of the DC-AC power converting unit and charging and discharging switching of the charging and discharging unit.
